(19) United States
(12) Patent Application Publication
(10) Pub. No.: US 2013/0057394 A1
(43) Pub. Date: Mar. 7, 2013

(54) Method and Apparatus for Providing Context Sensing and Fusion

(71) Applicants: Rajasekaran Andiappan, Tampere (FI); Antti Eronen, Tampere (FI); Jussi Artturi Leppänen, Tampere (FI)

(72) Inventors: Rajasekaran Andiappan, Tampere (FI); Antti Eronen, Tampere (FI); Jussi Artturi Leppänen, Tampere (FI)

(73) Assignee: NOKIA CORPORATION, Espoo (FI)

(21) Appl. No.: 13/697,309

(22) PCT Filed: May 13, 2010
(86) PCT No.: PCT/IB2010/001109

§ 371 Date: Nov. 9, 2012

(51) Int. Cl. H04Q 5/22

(52) U.S. Cl. 340/10.51

(57) ABSTRACT

A method for providing context sensing and fusion may include receiving physical sensor data extracted from one or more physical sensors, receiving virtual sensor data extracted from one or more virtual sensors, and performing context fusion of the physical sensor data and the virtual sensor data at an operating system level. A corresponding computer program product and apparatus are also provided.

### TECHNOLOGICAL FIELD

Various implementations relate generally to electronic communication device technology and, more particularly, relate to a method and apparatus for providing context sensing and fusion.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. Alternatively, the network device may respond to commands or requests made by the user (e.g., content searching, mapping or routing services, etc.). The services may be provided from a network server or other network device, or even from the mobile terminal such as, for example, a mobile telephone, a mobile navigation system, a mobile computer, a mobile television, a mobile gaming system, etc.

The ability to provide various services to users of mobile terminals can often be enhanced by tailoring services to particular situations or locations of the mobile terminals. Accordingly, various sensors have been incorporated into mobile terminals. Each sensor typically gathers information relating to a particular aspect of the context of a mobile terminal such as location, speed, orientation, and/or the like. The information from a plurality of sensors can then be used to determine device context, which may impact the services provided to the user.

Despite the utility of adding sensors to mobile terminals, some drawbacks may occur. For example, fusing data from all the sensors may be a drain on the resources of the mobile terminal. Accordingly, it may be desirable to improve sensor integration.

### BRIEF SUMMARY

A method, apparatus and computer program product are therefore provided to enable the provision of context sensing and fusion. Accordingly, for example, sensor data may be fused together in a more efficient manner. In some examples, sensor integration may further include the fusion of both physical and virtual sensor data. Moreover, in some embodiments, the fusion may be accomplished at the operating system level. In an example embodiment, the fusion may be accomplished via a coprocessor that is dedicated to pre-processing fusion of physical sensor data so that the pre-processed physical sensor data may then be fused with virtual sensor data more efficiently.

In one example embodiment, a method of providing context sensing and fusion is provided. The method may include receiving physical sensor data extracted from one or more physical sensors, receiving virtual sensor data extracted from one or more virtual sensors, and performing context fusion of the physical sensor data and the virtual sensor data at an operating system level.

In another example embodiment, a computer program product for providing context sensing and fusion is provided. The computer program product includes at least one computer-readable storage medium having computer-executable program code instructions stored therein. The computer-executable program code instructions may include program code instructions for receiving physical sensor data extracted from one or more physical sensors, receiving virtual sensor data extracted from one or more virtual sensors, and performing context fusion of the physical sensor data and the virtual sensor data at an operating system level.

In another example embodiment, an apparatus for providing context sensing and fusion is provided. The apparatus may include at least one processor and at least one memory including computer program code. The at least one memory and the computer program code may be configured to, with the at least one processor, cause the apparatus to perform at least receiving physical sensor data extracted from one or more physical sensors, receiving virtual sensor data extracted from one or more virtual sensors, and performing context fusion of the physical sensor data and the virtual sensor data at an operating system level.

### BRIEF DESCRIPTION OF THE DRAWING(S)

Having thus described various embodiments in general terms, reference will now be made to the accompanying drawings, which are not necessarily drawn to scale, and wherein:

FIG. 1 is a schematic block diagram of a mobile terminal that may employ an example embodiment;

FIG. 2 is a schematic block diagram of a wireless communications system according to an example embodiment;

FIG. 3 illustrates a block diagram of an apparatus for providing context sensing and fusion according to an example embodiment;

FIG. 4 illustrates a conceptual block diagram of the distributed sensing process provided by an example embodiment;

FIG. 5 illustrates an implementation architecture for providing context sensing and fusion according to an example embodiment;

FIG. 6 illustrates an alternative implementation architecture for providing context sensing and fusion according to an example embodiment;

FIG. 7 illustrates an example of device environment and user activity sensing based on audio and accelerometer information according to an example embodiment;

FIG. 8 illustrates an example microcontroller architecture for a sensor processor according to an example embodiment; and

FIG. 9 is a flowchart according to another example method for providing context sensing and fusion according to an example embodiment.

### DETAILED DESCRIPTION

Some embodiments will now be described more fully hereinafter with reference to the accompanying drawings, in which some, but not all embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments. Thus, use of any such terms should not be taken to limit the spirit and scope of various embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Some embodiments may be used to perform sensor integration more efficiently. Since conventional onboard sensors of hand-held devices (e.g., mobile terminals) are typically interfaced to the main processor of the devices via I2C/SPI (inter-integrated circuit/serial peripheral interface) interfaces, pre-processing of raw data and detection of events from the sensors is typically performed in the software driver layer. Thus, for example, data fusion for physical sensors may typically occur at low level drivers in the operating system base layer using the main processor. Accordingly, pre-processing and event detection is typically performed at the expense of the main processor. However, embodiments may provide a mechanism by which to improve sensor fusion. For example, embodiments may enable context fusion at the operating system level using both physical and virtual sensor data. Moreover, in some cases, a sensor co-processor may be employed to fuse physical sensor data. Some embodiments also provide for a mechanism by which to perform context sensing in a distributed fashion. In this regard, for example, context information may be determined (or sensed) based on inputs from physical and virtual sensors. After extraction of sensor data (which may define or imply context information) from the physical and/or virtual sensors, fusion may be accomplished on a homogeneous (for example, fusion contexts derived from physical sensors and operating system virtual sensors and the output is a fused context) or heterogeneous (for example, inputs are a combination of context information from lower layers and virtual sensor data). As such, the data that is fused at any particular operating system layer according to example embodiments could be either sensor data (physical and/or virtual) being fused with other sensor data, or sensor data being fused with context information from lower layers (which may itself include sensor data fused with other sensor data and/or context information from lower layers).

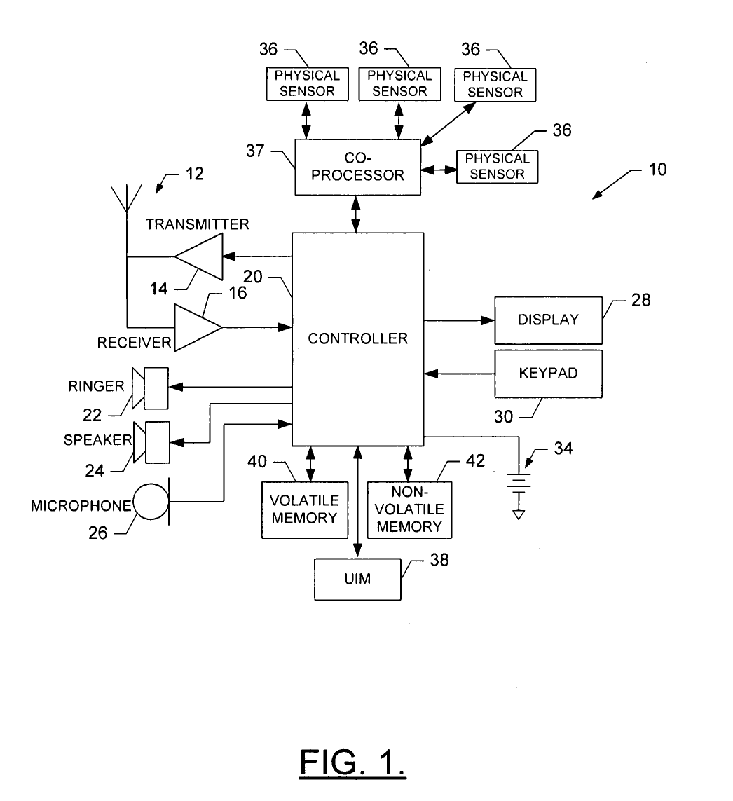

FIG. 1, one example embodiment, illustrates a block diagram of a mobile terminal 10 that would benefit from various embodiments. It should be understood, however, that the mobile terminal 10 as illustrated and hereinafter described is merely illustrative of one type of device that may benefit from various embodiments and, therefore, should not be taken to limit the scope of embodiments. As such, numerous types of mobile terminals, such as portable digital assistants (PDAs), mobile telephones, pagers, mobile televisions, gaming devices, laptop computers, cameras, video recorders, audio/video players, radios, positioning devices (for example, global positioning system (GPS) devices), or any combination of the aforementioned, and other types of voice and text communications systems, may readily employ various embodiments.

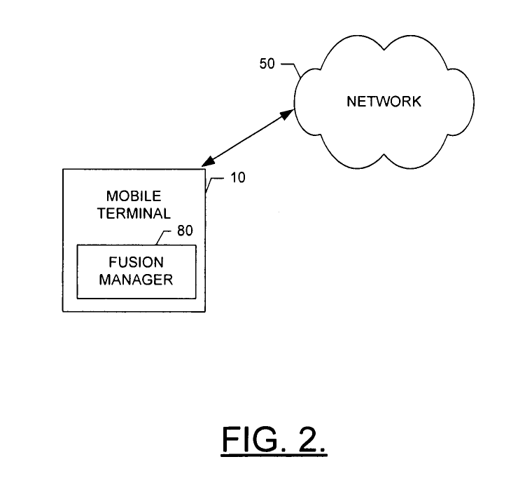

The mobile terminal 10 may include an antenna 12 (or multiple antennas) in operable communication with a transmitter 14 and a receiver 16. The mobile terminal 10 may further include an apparatus, such as a controller 20 or other processing device, which provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-UTRAN, with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WEAN) or other communication networks described below in connection with FIG. 2.

In some embodiments, the controller 20 may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In addition, the mobile terminal 10 may include one or more physical sensors 36. The physical sensors 36 may be devices capable of sensing or determining specific physical parameters descriptive of the current context of the mobile terminal 10. For example, in some cases, the physical sensors 36 may include respective different sending devices for determining mobile terminal environmental-related parameters such as speed, acceleration, heading, orientation, inertial position relative to a starting point, proximity to other devices or objects, lighting conditions and/or the like.

In an example embodiment, the mobile terminal 10 may further include a co-processor 37. The co-processor 37 may be configured to work with the controller 20 to handle certain processing tasks for the mobile terminal 10. In an example embodiment, the co-processor 37 may be specifically tasked with handling (or assisting with) context extraction and fusion capabilities for the mobile terminal 10 in order to, for example, interface with or otherwise control the physical sensors 36 and/or to manage the extraction and fusion of context information.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), and the like. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10. For example, the memories may include an identifier, such as an international mobile equipment identification (IMEI) code, capable of uniquely identifying the mobile terminal 10.

FIG. 2 is a schematic block diagram of a wireless communications system according to an example embodiment. Referring now to FIG. 2, an illustration of one type of system that would benefit from various embodiments is provided. As shown in FIG. 2, a system in accordance with an example embodiment includes a communication device (for example, mobile terminal 10) and in some cases also additional communication devices that may each be capable of communication with a network 50. The communications devices of the system may be able to communicate with network devices or with each other via the network 50.

In an example embodiment, the network 50 includes a collection of various different nodes, devices or functions that are capable of communication with each other via corresponding wired and/or wireless interfaces. As such, the illustration of FIG. 2 should be understood to be an example of a broad view of certain elements of the system and not an all inclusive or detailed view of the system or the network 50. Although not necessary, in some embodiments, the network 50 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the other communication devices may be capable of communication with each other via the network 50 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices or elements (for example, personal computers, server computers or the like) may be coupled to the mobile terminal 10 via the network 50. By directly or indirectly connecting the mobile terminal 10 and other devices to the network 50, the mobile terminal 10 and the other devices may be enabled to communicate with each other and/or the network, for example, according to numerous communication protocols including Hypertext Transfer Protocol (HTTP) and/or the like, to thereby carry out various communication or other functions of the mobile terminal 10 and the other communication devices, respectively.

Furthermore, although not shown in FIG. 2, the mobile terminal 10 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 may be enabled to communicate with the network 50 and other communication devices by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

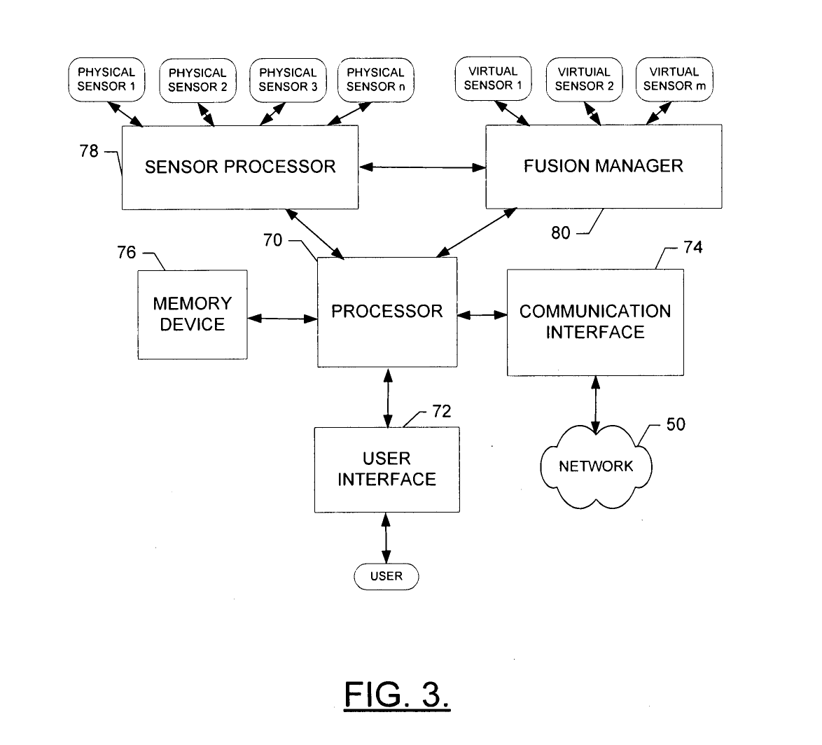

FIG. 3 illustrates a block diagram of an apparatus that may be employed at the mobile terminal 10 to host or otherwise facilitate the operation of an example embodiment. An example embodiment will now be described with reference to FIG. 3, in which certain elements of an apparatus for providing context sensing and fusion are displayed. The apparatus of FIG. 3 may be employed, for example, on the mobile terminal 10. However, the apparatus may alternatively be embodied at a variety of other devices, both mobile and fixed (such as, for example, any of the devices listed above). Furthermore, it should be noted that the devices or elements described below may not be mandatory and thus some may be omitted in certain embodiments.

Referring now to FIG. 3, an apparatus for providing context sensing and fusion is provided. The apparatus may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (for example, a computer readable storage medium) comprising gates configured to store data (for example, bits) that may be retrievable by a machine (for example, a computing device). The memory device 76 may be configured to store information, data, applications, instructions or the like for enabling the apparatus to carry out various functions in accordance with example embodiments. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a microprocessor, a controller, a digital signal processor (DSP), a processing device with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, processing circuitry, or the like. In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (for example, the mobile terminal 10 or other communication device) adapted for employing various embodiments by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an example embodiment in which the apparatus is embodied as a server or some other network devices, the user interface 72 may be limited, or eliminated. However, in an embodiment in which the apparatus is embodied as a communication device (for example, the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (for example, memory device 76, and/or the like).

In an example embodiment, the apparatus may further include a sensor processor 78. The sensor processor 78 may have similar structure (albeit perhaps with semantic and scale differences) to that of the processor 70 and may have similar capabilities thereto. However, according to an example embodiment, the sensor processor 78 may be configured to interface with one or more physical sensors (for example, physical sensor 1, physical sensor 2, physical sensor 3, . . . , physical sensor n, where n is an integer equal to the number of physical sensors) such as, for example, an accelerometer, a magnetometer, a proximity sensor, an ambient light sensor, and/or any of a number of other possible sensors. In some embodiments, the sensor processor 78 may access a portion of the memory device 76 or some other memory to execute instructions stored thereat. Accordingly, for example, the sensor processor 78 may be configured to interface with the physical sensors via sensor specific firmware that is configured to enable the sensor processor 78 to communicate with each respective physical sensor. In some embodiments, the sensor processor 78 may be configured to extract information from the physical sensors (perhaps storing such information in a buffer in some cases), perform sensor control and management functions for the physical sensors and perform sensor data pre-processing. In an example embodiment, the sensor processor 78 may also be configured to perform sensor data fusion with respect to the physical sensor data extracted. The fused physical sensor data may then be communicated to the processor 70 (for example, in the form of fusion manager 80, which is described in greater detail below) for further processing. In some embodiments, the sensor processor 78 may include a host interface function for managing the interface between the processor 70 and the sensor processor 78 at the sensor processor 78 end. As such, the sensor processor 78 may be enabled to provide data from the physical sensors, status information regarding the physical sensors, control information, queries and context information to the processor 70.

In an example embodiment, the processor 70 may be embodied as, include or otherwise control the fusion manager 80. As such, in some embodiments, the processor 70 may be said to cause, direct or control the execution or occurrence of the various functions attributed to the fusion manager 80 as described herein. The fusion manager 80 may be any means such as a device or circuitry operating in accordance with software or otherwise embodied in hardware or a combination of hardware and software (for example, processor 70 operating under software control, the processor 70 embodied as an ASIC or FPGA specifically configured to perform the operations described herein, or a combination thereof) thereby configuring the device or circuitry to perform the corresponding functions of the geo-fusion manager 80 as described herein. Thus, in examples in which software is employed, a device or circuitry (for example, the processor 70 in one example) executing the software forms the structure associated with such means.

The fusion manager 80 may be configured to communicate with the sensor processor 78 (in embodiments that employ the sensor processor 78) to receive pre-processed physical sensor data and/or fused physical sensor data. In embodiments where no sensor processor 78 is employed, the fusion manager 80 may be further configured to pre-process and/or fuse physical sensor data. In an example embodiment, the fusion manager 80 may be configured to interface with one or more virtual sensors (for example, virtual sensor 1, virtual sensor 2, . . . , virtual sensor m, where m is an integer equal to the number of virtual sensors) in order to fuse virtual sensor data with physical sensor data. Virtual sensors may include sensors that do not measure physical parameters. Thus, for example, virtual sensors may monitor such virtual parameters as RF activity, time, calendar events, device state information, active profiles, alarms, battery state, application data, data from webservices, certain location information that is measured based on timing (for example, GPS position) or other non-physical parameters (for example, cell-ID), and/or the like. The virtual sensors may be embodied as hardware or as combinations of hardware and software configured to determine the corresponding non-physical parametric data associated with each respective virtual sensor. In some embodiments, the fusion of virtual sensor data with physical sensor data may be classified into different levels. For example, context fusion may occur at the feature level, which may be accomplished at a base layer, at a decision level, which may correspond to middleware, or in independent applications, which may correspond to an application layer. The fusion manager 80 may be configured to manage context fusion (for example, the fusion of virtual and physical sensor data related to context information) at various ones and combinations of the levels described above.

Thus, according to some example embodiments, context data extraction and fusion of the context data that has been extracted may be performed by different entities, processors or processes in a distributed fashion or layered/linear way. A set of physical sensors may therefore be interfaced with the sensor processor 78, which is configured to manage physical sensors, pre-processes physical sensor data and extract a first level of context data. In some embodiments, the sensor processor 78 may perform data level context fusion on the physical sensor data. The sensor processor 78 may be configured to use pre-processed data and context from other subsystems that may have some type of physical data source (for example, modem, RF module, AV module; GPS subsystems, etc.) and perform a context fusion. In some embodiments, a second level, and perhaps also subsequent levels, of context fusion may be performed to fuse the physical sensor data with virtual sensor data using the processor 70 (for example, via the fusion manager 80). As such, the fusion manager 80 may fuse virtual sensor data and physical sensor data in the operating system layers of the apparatus.

As the processor 70 itself is a processor running an operating system, the virtual context fusion processes running in the processor 70 (for example, in the form of the fusion manager 80) may have access to the context and physical sensor data from the sensor processor 78. The processor 70 may also have access to other subsystems with physical data sources and the virtual sensors. Thus, a layered or distributed context sensing process may be provided.

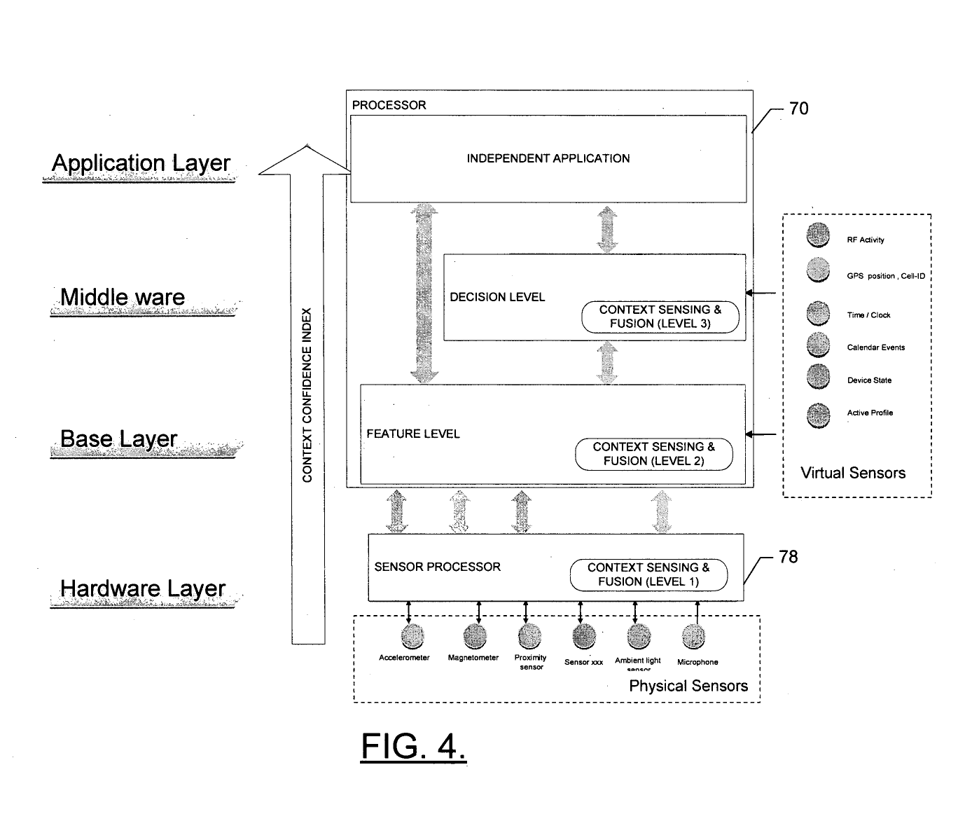

FIG. 4 illustrates a conceptual block diagram of the distributed sensing process provided by an example embodiment. As shown in FIG. 4, each context fusion process running in different layers of the operating system of the processor 70 may add more information to the context and increases a context confidence index. Accordingly, by increasing the context confidence index, more reliable context information may ultimately be generated for use in connection with providing services to the user. In this regard, for example, the sensor processor 78 may perform context sensing and fusion on the physical sensor data received thereat in a first level of context fusion at the hardware layer. A second level of context fusion may then take place at the processor 70 (for example, via the fusion manager 80) by fusing the physical sensor data with some virtual sensor data at the feature level corresponding to the base layer. A third level of context fusion may then take place at the processor by fusing the context data fused at the feature level with additional virtual sensor data. The third level of context fusion may occur at the decision level and add to the context confidence index. Accordingly, when the context information is provided to an independent application at the application layer, a higher confidence may be placed in the context data used by the independent application. It should be appreciated that the example of FIG. 4 can be scaled to any number of operating system layers. Thus, in some example embodiments, context fusion processes may be run in any operating system layers such that the number of context fusion processes is not limited to three as shown in FIG. 4.

It should also be appreciated that the independent application may perform yet another (for example, a fourth level) of context sensing and fusion. Moreover, as is shown in FIG. 4, the independent application may have access to both level 2 and level 3 context information. Thus, the independent application may be enabled to perform context fusion involving context information from multiple preceding levels or even selectively incorporate context information from specific desired ones of the preceding levels in some embodiments.

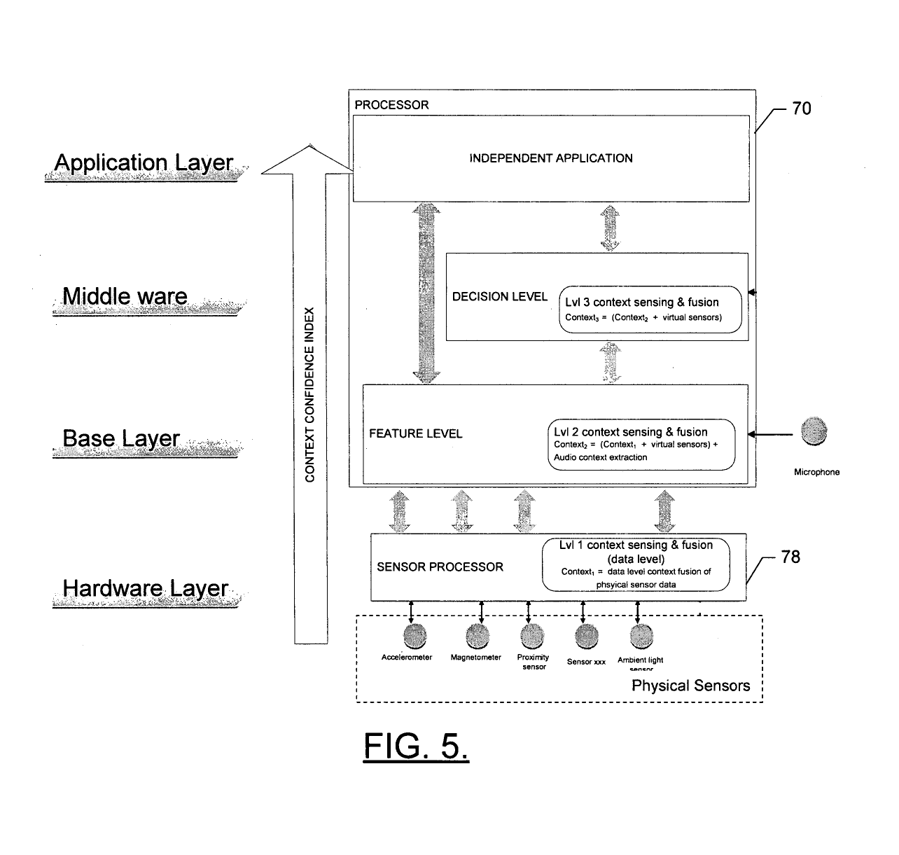

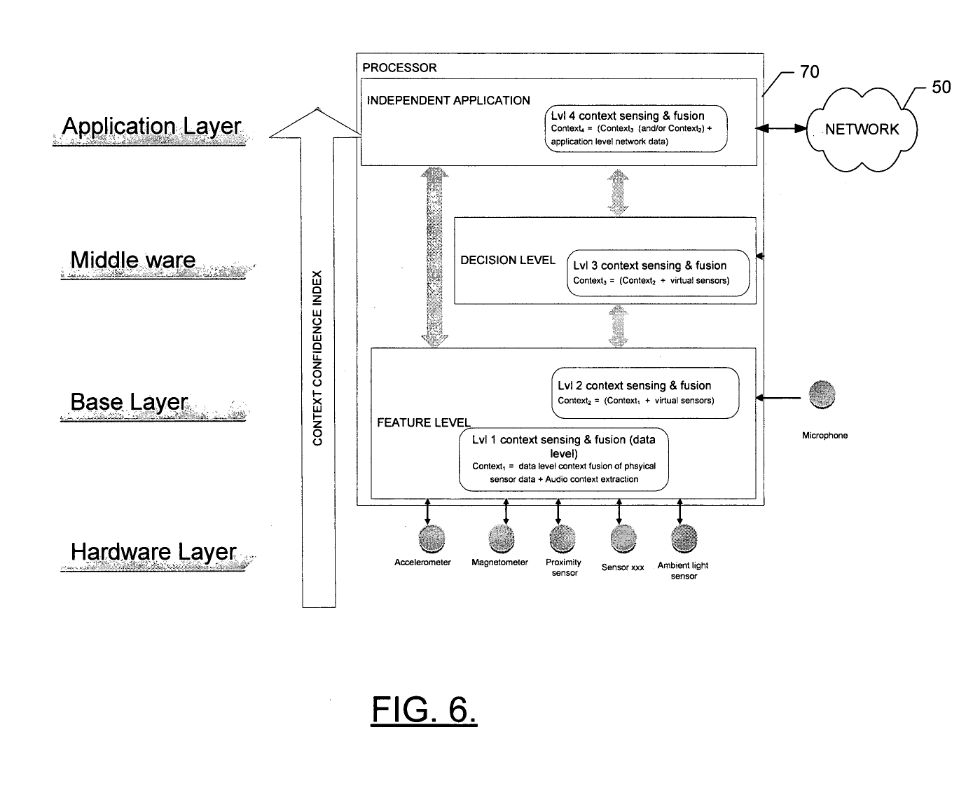

FIGS. 5 and 6 illustrate different implementation architectures according to various different and non-limiting examples. As such, it should be appreciated that the implementation architecture employed may be different in respective different example embodiments. For example, instead of audio data being interfaced into the sensor processor 78 (shown in FIG. 4 by virtue, of the microphone being provided as an input to the sensor processor 78), the audio data could instead be interfaced directly to the processor 70 as is shown in FIG. 5. In this regard, in FIG. 5, all of the physical sensors and a microphone are interfaced to the sensor processor 78. Level 1 or data level context extraction and fusion may then be performed in the sensor processor 78 and the context data that results may be communicated to the processor 70 (for example, when requested or when a change of event occurs). Data corresponding to Context₁ may therefore be defined as a set of fused context data derived from a set of context data sensed by the physical sensors. Level 2 context fusion may then occur in the base layer (for example, feature level fusion) which involves the basic context generated during level 1 context fusion and virtual sensor data from one or more virtual sensors to create more reliable context information with a time stamp. As such, Context₂ may be formed from the fusion of Context₁ with virtual sensor data or contexts fused with context information from the audio based context sensing. The middleware may then perform level 3 context fusion with additional virtual sensor data that may be different than the virtual sensor data involved in context fusion used in the base layer for level 2 context fusion. As such, Context₃ may be formed from the fusion of Context₂ with virtual sensor data or context information. Thus, FIG. 4 differs from FIG. 5 in that the example embodiment of FIG. 5 performs audio based context extraction via the processor 70, while the example embodiment of FIG. 4 performs audio based context extraction via the sensor processor 78. As such, fusion of audio context data may occur at the base layer rather than in the hardware layer (as is the case in FIG. 4).

FIG. 6 illustrates another example embodiment in which the sensor processor 78 is excluded. In the embodiment of FIG. 6, all of the sensors (virtual and physical) are interfaced to the processor 70 and level 1 fusion may be performed at a data level by the processor 70, and may include fusion with the audio context data. Thus, data corresponding to Context, may therefore be defined as a set of fused context data derived from a set of context data sensed by the physical sensors, fused also with the audio context data. Level 2 context extraction and fusion may be performed in the operating system base layer to fuse the level 1 context data (e.g., Context₁) with virtual sensor data to provide level 2 context data (e.g., Context₂). The level 3 context processes may be run in middleware to produce level 3 context data (e.g., Context₃) based on a fusion of the level 2 context data with additional virtual sensor data. As described above, in some cases, the independent application may perform a fourth level of context fusion since the independent application may have access to both level 2 and level 3 context information. Moreover, the independent application could also be in communication with the network 50 (or a web service or some other network device) to perform application level context fusion.

As may be appreciated, the embodiment of FIG. 4 may result in less loading of the processor 70, since all physical sensor data is extracted, pre-processed and fusion of such data is accomplished by the sensor processor 78. Thus, for example, sensor pre-processing, context extraction, sensor management, gesture/event detection, sensor calibration/compensation and level 1 context fusion are performed in a dedicated, low-power device, namely the sensor processor 78, which may enable continuous and adaptive context sensing.

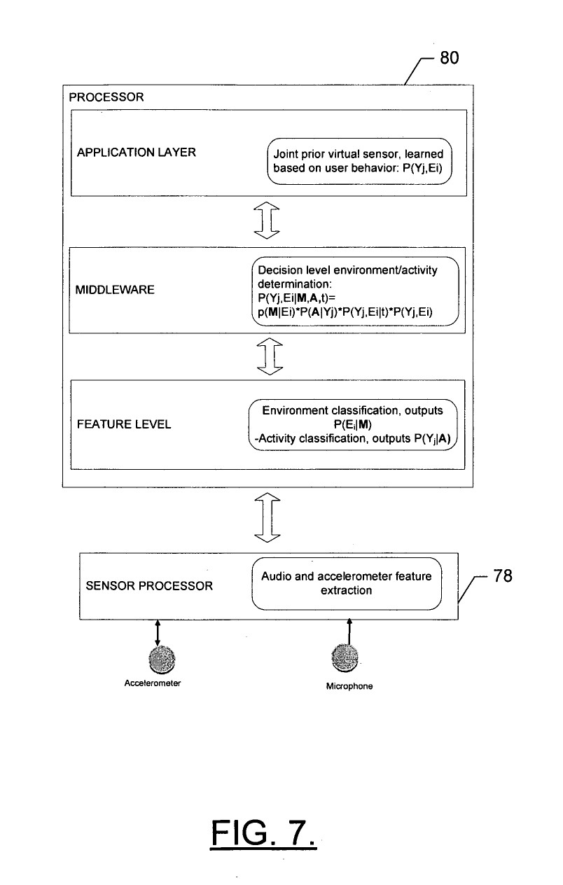

A specific example will now be described for purposes of explanation and not of limitation in reference to FIG. 7. FIG. 7 illustrates an example of device environment and user activity sensing based on audio and accelerometer information according to an example embodiment. However, several other device environments could alternatively be employed.

As shown in FIG. 7, audio-context extraction may be implemented with any of various methods. In one example, which is described below to illustrate one possible series of processing operations that the sensor processor 78 may employ, an acoustic signal captured by the microphone may be digitized with an analog-to-digital converter. The digital audio signal may be represented (e.g. at a sampling rate of 8 kHz and 16-bit resolution). Features may then be extracted from the audio signal (e.g., by extracting and windowing frames of the audio signal with a frame size of 30 ms, corresponding to 240 samples at 8 kHz sampling rate). Adjacent frames may have overlap in some cases or, in other cases, there may be no overlap at all and there may instead be a gap between adjacent frames. In one example, the frame shift may be 50 ms. The frames may be windowed with a hamming window and, in some examples, may be zero-padded. After zero-padding, the frame length may be 256. A Fast Fourier Transform (FFT) may be taken of the signal frames, and its squared magnitude may be computed. The resulting feature vector in this example represents the power of various frequency components in the signal. Further processing may be done for this vector to make the representation more compact and better suitable for audio-environment recognition. In one example, mel-frequency cepstral coefficients (MFCC) are calculated. The MFCC analysis involves binning the spectral power values into a number of frequency bands spaced evenly on the mel frequency scale. In one example, 40 bands may be used. A logarithm may be taken of the band energies, and a discrete cosine transform (DCT) may be calculated of the logarithmic band energies to get an uncorrelated feature vector representation. The dimensionality of this feature vector may be, for example, 13. In addition, first and second order time derivatives may be approximated from the cepstral coefficient trajectories, and appended to the feature vector. The dimension of the resulting feature vector may be 39.

Meanwhile, the sensor processor 78 may also implement feature extraction for the accelerometer signal. The raw accelerometer signal may be sampled (e.g., at a sampling rate of 100 Hz) and may represent the acceleration into three orthogonal directions, x, y, z. In one embodiment, feature extraction starts by taking a magnitude of the three dimensional acceleration, to result in a one-dimensional signal. In another example embodiment, a projection onto a vector is taken of the accelerometer signal to obtain a one-dimensional signal. In other embodiments, the dimensionality of the accelerometer signal subjected to feature extraction may be larger than one. For example, the three-dimensional accelerometer signal could be processed as such, or a two-dimensional accelerometer signal including two different projections of the original three-dimensional accelerometer signal could be used.

Feature extraction may, for example, comprise windowing the accelerometer signal, taking a Discrete Fourier Transform (DFT) of the windowed signal, and extracting features from the DFT. In one example, the features extracted from the DFT include, for example, one or more spectrum power values, power spectrum centroid, or frequency-domain entropy. In addition to features based on the DFT, the sensor processor 78 may be configured to extract features from the time-domain accelerometer signal. These time-domain features may include, for example, mean, standard deviation, zero crossing rate, 75% percentile range, interquartile range, and/or the like.

Various other processing operations may also be performed on the accelerometer data. One example includes running a step counter to estimate the step count and step rate for a person. Another example includes running an algorithm for step length prediction, to be used for pedestrian dead reckoning. Yet another example includes running a gesture engine, which detects a set of gestures, such as moving a hand in a certain manner. Inputs related to each of these processing operations may also be extracted and processed for context fusion as described in greater detail below in some cases.

After extraction of the audio and accelerometer feature data by the sensor processor 78, the sensor processor 78 may pass the corresponding audio features M and accelerometer features A to the processor for context fusion involving virtual sensor data. Base layer audio processing according to one example embodiment may include communication of the MFCC feature vectors extracted above from the sensor processor 78 to the base layer of the processor 70 to produce a set of probabilities for audio context recognition. In some cases, to reduce the data rate communicated to the processor 70, the processor 70 may read raw audio data, e.g., using a single channel audio input running at 8000 kHz sampling rate and 16-bit resolution audio samples, to correspond to a data rate of 8000*2=16000 bytes/s. When communicating only the audio features, with a frame skip of 50 ms, the data rate would become about 1000/50*39*2=1560 bytes/s (assuming features represented at 16-bit resolution).

Audio context recognition may be implemented e.g. by training a set of models for each audio environment in an off-line training stage, storing the parameters of the trained models in the base layer, and then evaluating the likelihood of each model generating the sequence of input features in the online testing stage with software running in the base layer. As an example, Gaussian mixture models (GMM) may be used. The GMM parameters, which include the component weights, means, and covariance matrices, may be trained in an off-line training stage using a set of labeled audio data and the expectation maximization (EM) algorithm. The audio context recognition process in the base layer may receive a sequence of MFCC feature vectors as an input, and evaluate the likelihood of each context GMM having generated the features. The likelihoods p(M|Eᵢ), for the set of environments Eᵢ, i=1, . . . , N, where M is a sequence of MFCC feature vectors and N the number of environments trained in the system, may be communicated further to the middleware.

In some optional cases, a form of feature level fusion may be employed in the base layer. For example, features produced by another sensor, such as an accelerometer or illumination sensor, could be appended to the MFCC features, and used to generate the probabilities for environments E.

In some embodiments, the sensor processor 78 may also be configured to perform audio context recognition or activity recognition. For example, in the case of audio context recognition, GMMs with quantized parameters, which enable implementing the classification in a computationally efficient manner with lookup operations, may be utilized. An example benefit of this may be to further reduce the amount of data to be communicated to the base layer. For example, the sensor processor could communicate e.g. the likelihoods p(M|Eᵢ) of the environments at a fixed interval such as every 3 seconds.

In one example embodiment, processing of accelerometer data at the base layer may include receiving a feature vector from the sensor processor 78 at regular time intervals (e.g., every 1 second). Upon receiving the feature vector, the base layer may perform classification on the accelerometer feature vector. In one embodiment, activity classification may be performed using the accelerometer feature vector. This can be implemented in some examples by training a classifier, such as a k-Nearest neighbors or any other classifier, for a set of labeled accelerometer data from which features are extracted. In one embodiment, a classifier is trained for classifying between running, walking, idle/still, bus/car, bicycling, and skateboarding activities. The activity classifier may produce probabilities P(A|Yⱼ) for the set of activities j=1, . . . , M. A may include at least one feature vector based on the accelerometer signal. In the case of the k-Nearest neighbors classifier, the probability for activity Y, may be calculated as, for example, a proportion of samples from class Yᵢ among the set of nearest neighbors (e.g. 5 nearest neighbors). In other embodiments, various other classifiers may be applied, such as Naïve Bayes, Gaussian Mixture Models, Support Vector Machines, Neural Networks, and so on.

The software implemented on the middleware may receive various hypotheses from the base layer, and may perform decision level fusion to give a final estimate of the context. In one embodiment, the middleware receives a likelihood for the environment based on the audio features p(M|Eᵢ), a probability for the activity based on the accelerometer data P(A|Yⱼ), and forms a final hypothesis of the most likely environment and activity pair given the sensory hypotheses and one or more virtual sensors. In some embodiments, an example virtual sensor input may be a clock input so that a time prior may be included in the determination regarding the likely environment. The time prior may represent the prior likelihoods for environments, activities, and/or their combinations. The method of incorporating the time prior may be, for example, the one described in the patent application PCT/IB2010/051008, “Adaptable time-based priors for automatic context recognition” by Nokia Corporation, filed 9 Mar. 2010, the disclosure of which is incorporated herein by reference.

As another example, prior information may be incorporated to the decision in the form of a virtual sensor. The prior information may represent, for example, prior knowledge of the common occurrence of different activities and environments. More specifically, the prior information may output a probability P(Yⱼ,Eᵢ) for each combination of environment Eᵢ and activity Yⱼ. The probabilities may be estimated offline from a set of labeled data collected from a set of users, comprising the environment and activity pair. As another example, information on common environments and activities may be collected from the user in the application layer, and communicated to the middleware. As another example, the values of pⱼᵢ=P(Yⱼ,Eᵢ) may be selected as follows:

| | car/bus | home | mee/lec | off | out | res/pub | sho | str/roa | tra/met |
|---|---|---|---|---|---|---|---|---|---|
| Idle/still | 0.00 | 0.25 | 0.06 | 0.27 | 0.01 | 0.03 | 0.02 | 0.01 | 0.00 |
| Walk | 0.00 | 0.01 | 0.00 | 0.01 | 0.02 | 0.01 | 0.01 | 0.02 | 0.00 |
| Run | 0.00 | 0.00 | 0.00 | 0.00 | 0.01 | 0.00 | 0.01 | 0.01 | 0.00 |
| Train/metro/tram | 0.00 | 0.00 | 0.00 | 0.00 | 0.00 | 0.00 | 0.00 | 0.00 | 0.01 |
| Car/bus/motorbike | 0.04 | 0.00 | 0.00 | 0.00 | 0.00 | 0.00 | 0.00 | 0.00 | 0.00 |
| Bicycle | 0.00 | 0.00 | 0.00 | 0.00 | 0.00 | 0.00 | 0.00 | 0.01 | 0.00 |
| Skateboard | 0.00 | 0.00 | 0.00 | 0.00 | 0.01 | 0.00 | 0.00 | 0.01 | 0.00 |

where, the environments Eᵢ, =1, . . . , 9; are car/bus, home, meeting/lecture, office, outdoors, restaurant/pub, shop, street/road, and train/metro. The activities Yⱼ, j=1, . . . , 7, are idle/still, walking, running, train/metro/tram, car/bus/motorbike, bicycling, and skateboarding. As another example, instead of probabilities, the values of pⱼᵢ can either ones or zeros, representing only which environment-activity pairs are allowed.

In one embodiment, the middleware may perform decision level data fusion by selecting the environment and activity combination which maximizes the equation P(Yⱼ, Eᵢ|M,A,t)=p(M|Eᵢ)*P(A|Yⱼ)*P(Yⱼ,Eᵢ|t)*P(Yⱼ,Eᵢ), where P(Yⱼ,Eᵢ|t) is a probability for the environment and activity combination from the time prior. This is communicated further to the application layer. It can be noted that maximizing the above equation can be done also by maximizing the sum of the logarithms of the terms, that is, by maximizing log[p(M|Eᵢ)]+log[P(A|Yⱼ)]+log[P(Yⱼ,Eᵢ|t)]+log[P(Yⱼ,Eᵢ)], where log is e.g., the natural logarithm.

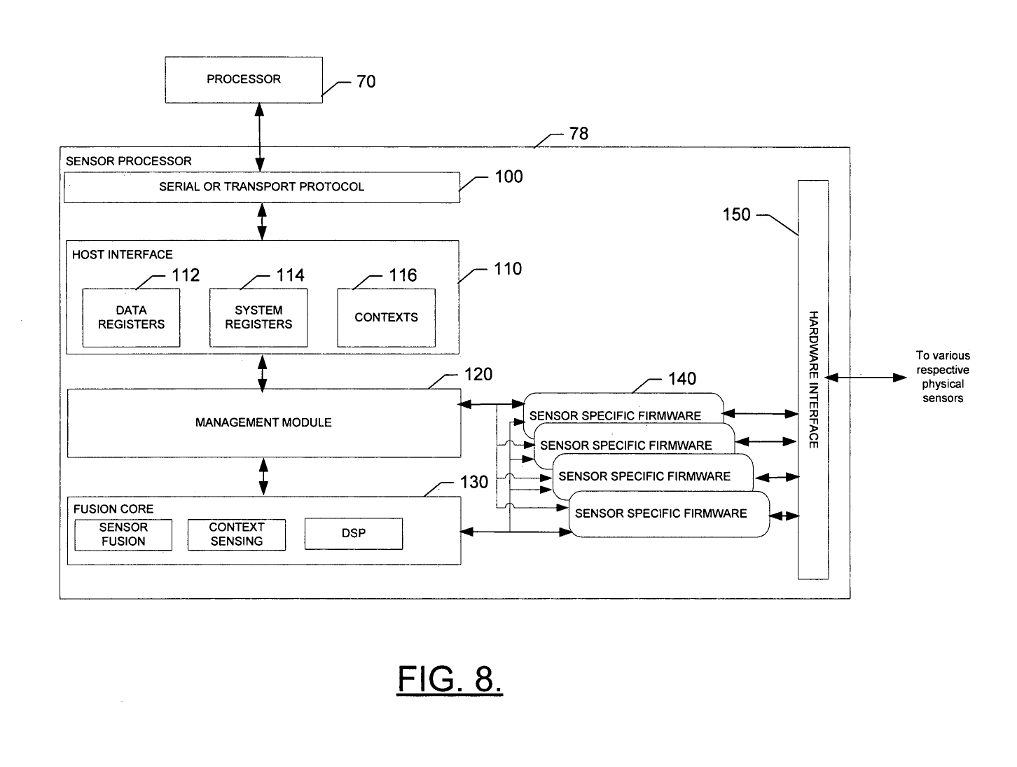

FIG. 8 illustrates an example microcontroller architecture for the sensor processor 78 according to an example embodiment. As shown in FIG. 8, the sensor processor 78 may include a communication protocol defining an interface with the processor 70. In some cases, the communication protocol could be a serial or transport protocol 100 to interface with the processor 70. The sensor processor 78 may also include a host interface (e.g., a register mapped interface) 110 including data registers 112 (e.g., proximity, light, feature vectors, etc.), system registers 114 (e.g., sensor control, sensor status, context control, context status, etc.) and a list of corresponding contexts 116 (e.g., environmental, activity, user, orientation, gestures, etc.). The sensor processor 78 may also include a management module 120 to handle event management and control and a fusion core 130 to handle sensor pre-processing, various hardware accelerated signal processing operations, context sensing and/or sensor fusion operations with corresponding algorithms. As such, the fusion core 130 may include sub-modules such as, for example, a sensor fusion module, a context sensing module, a DSP, etc. The management module 120 and the fusion core 130 may each be in communication with sensor specific firmware modules 140 and a hardware interface 150 through which communications with the hardware of each of the physical sensors are passed.

Accordingly, some example embodiments may employ a single interface to connect an array of sensors to baseband hardware. High speed I2C/SPI serial communication protocols with register mapped interface may be employed along with communication that is INT (interrupt signal) based. Moreover, the host resources (e.g., the main processor) may only be involved to the extent needed. Thus, some embodiments may provide for relatively simple and lean sensor kernel drivers. For example, embodiments may read only pre-processed sensor data and events and provide sensor architectural abstraction to higher operating system layers. No change may be required in kernel drivers due to sensor hardware changes and minimal architectural impact may be felt in middleware and higher operating system layers. In some embodiments, the sensor processor may deliver preprocessed data to the host. This may be characterized by a reduction in data rate and reduced processing in the host engine side while unit conversion, scaling and preprocessing of sensor data can be performed at the microcontroller level. Specialized/complex DSP algorithms may be performed on sensor data in the microcontroller level to support close to real time sensor and event processing. Sensor data may therefore be processed at higher data rates with faster and more accurate responses. In some cases, host response time may also be more predictable.

In some embodiments, improved energy management may also be provided in the subsystem level. For example, sensor power management may be done in the hardware level and a sensor control and manager module may optimize sensor on/off times to improve performance while saving power. Continuous and adaptive context sensing may also be possible. Context sensing, event detection, gestures determining algorithms, etc., may be enabled to run continuously using less power than running in the host engine side. Thus, adaptive sensing for saving power may be feasible. In some embodiments, event/gesture detection may be performed at the microcontroller level. In an example embodiment, accelerometer data may be used to perform tilt compensation and compass calibration. Context extraction and continuous context sensing may therefore be feasible in a variety of contexts. For example, environmental context (indoor/outdoor, home/office, street/road, etc.), user context (active/idle, sitting/walking/running/cycling/commuting, etc.) and terminal context (active/idle, pocket/desk, charging, mounted, landscape/portrait, etc.). Context confidence index may therefore be increased as the context propagates to upper operating system layers and when further context fusion with virtual sensors is done. Thus, for example, attempts to determine the current context or environment of the user, which may in some cases be used to enhance services that can be provided to the user, may be more accurately determined. As a specific example, physical sensor data may be extracted indicate that the user is moving in a particular pattern, and may also indicate a direction of motion and perhaps even a location relative to a starting point. The physical sensor data may then be fused with virtual sensor data such as the current time and the calendar of the user to determine that the user is transiting to a particular meeting that is scheduled at a corresponding location. Thus, by performing sensor data fusion, which according to example embodiments can be done in a manner that does not heavily load the main processor, a relatively accurate determination may be made as to the user's context.

Apart from context extraction at the baseband hardware subsystem level, some embodiments may further enable distributed context extraction and fusion. A first level of continuous context extraction and fusion may be performed with respect to physical sensor data in a dedicated low-power sensor processor configured to perform continuous sensor pre-processing, sensor management, context extraction and communication with a main processor when appropriate. The main processor may host the base layer, middleware and application layer and context information related to physical sensors from the sensor processor may then be fused with virtual sensor data (clock, calendar, device events, and the like.) at the base layer, middleware and/or application layer for providing more robust, accurate and decisive context information. At every operating system layer, various embodiments may enable decisions to be made based on the context to optimize and deliver improved device performance. Some embodiments may also enable applications and services to utilize the context information to provide proactive and context based services, with an intuitive and intelligent user interface based on device context.

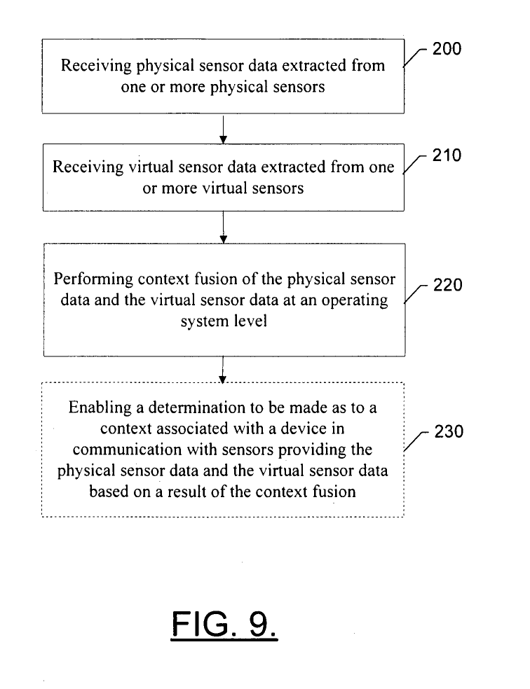

FIG. 9 is a flowchart of a method and program product according to example embodiments. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, a method according to one embodiment, as shown in FIG. 9, may include receiving physical sensor data extracted from one or more physical sensors at operation 200. The method may further include receiving virtual sensor data extracted from one or more virtual sensors at operation 210 and performing context fusion of the physical sensor data and the virtual sensor data at an operating system level at operation 220.

In some embodiments, certain ones of the operations above may be modified or further amplified as described below. Moreover, in some embodiments additional optional operations may also be included (an example of which is shown in dashed lines in FIG. 9). It should be appreciated that each of the modifications, optional additions or amplifications below may be included with the operations above either alone or in combination with any others among the features described herein. In an example embodiment, the method may further include determining (or enabling a determination to be made as to) a context associated with a device in communication with sensors providing the physical sensor data and the virtual sensor data based on a result of the context fusion at operation 230. In some embodiments, receiving physical sensor data may include receiving physical sensor data at a processor in communication with the one or more physical sensors. The processor may also be in communication with the one or more virtual sensors to receive the virtual sensor data and perform context fusion of the physical sensor data received with the virtual sensor data received. In some embodiments, receiving physical sensor data may include receiving physical sensor data from a sensor processor in communication with the one or more physical sensors. The sensor processor being in communication with a processor configured to receive the virtual sensor data and perform context fusion of the physical sensor data received with the virtual sensor data received. In some cases, the sensor processor may be configured to perform a first layer of context fusion. In such cases, receiving physical sensor data may include receiving a result of the first layer of context fusion, and performing context fusion may include performing the context fusion of the physical sensor data received with the virtual sensor data. In an example embodiment, performing context fusion of the physical sensor data and the virtual sensor data at an operating system level may include performing first level context fusion of physical sensor data received with a first set of virtual sensor data at a first layer of the operating system, and performing second level context fusion of a result of the first level context fusion with a second set of virtual sensor data at a second layer of the operating system. In some cases, performing context fusion of the physical sensor data and the virtual sensor data at an operating system level may include performing context fusion at a hardware level, performing context fusion at a feature level, and performing context fusion in middleware. In some examples, performing context fusion of the physical sensor data and the virtual sensor data at an operating system level may include one or more of performing context fusion at a hardware level, performing context fusion at a feature level, performing context fusion in middleware, and performing context fusion at an application layer.

In an example embodiment, an apparatus for performing the method of FIG. 9 above may comprise a processor (e.g., the processor 70) configured to perform some or each of the operations (200-230) described above. The processor may, for example, be configured to perform the operations (200-230) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-230 may comprise, for example, the processor 70, the fusion manager 80, and/or a device or circuit for executing instructions or executing an algorithm for processing information as described above.

Many modifications and other embodiments set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving physical sensor data extracted from one or more physical sensors;
receiving virtual sensor data extracted from one or more virtual sensors; and
performing context fusion of the physical sensor data and the virtual sensor data at an operating system level.

2. The method of claim 1, further comprising enabling a determination to be made as to a context associated with a device in communication with sensors providing the physical sensor data and the virtual sensor data based on a result of the context fusion.

3. The method of claim 1, wherein receiving physical sensor data comprises receiving physical sensor data at a processor in communication with the one or more physical sensors, the processor also being in communication with the one or more virtual sensors to receive the virtual sensor data and perform context fusion of the physical sensor data received with the virtual sensor data received.

4. The method of claim 1, wherein receiving physical sensor data comprises receiving physical sensor data from a sensor processor in communication with the one or more physical sensors, the sensor processor being in communication with a processor configured to receive the virtual sensor data and perform context fusion of the physical sensor data received with the virtual sensor data received.

5. The method of claim 4, wherein the sensor processor is configured to perform a first layer of context fusion, wherein receiving physical sensor data comprises receiving a result of the first layer of context fusion, and wherein performing context fusion comprises performing the context fusion of the physical sensor data received with the virtual sensor data.

6. The method of claim 1, wherein performing context fusion of the physical sensor data and the virtual sensor data at an operating system level comprises performing first level context fusion of physical sensor data received with a first set of virtual sensor data at a first layer of the operating system, and performing second level context fusion of a result of the first level context fusion with a second set of virtual sensor data at a second layer of the operating system.

7. The method of claim 1, wherein performing context fusion of the physical sensor data and the virtual sensor data at an operating system level comprises performing context fusion at a hardware level, performing context fusion at a feature level, and performing context fusion in middleware.

8. The method of claim 1, wherein performing context fusion of the physical sensor data and the virtual sensor data at an operating system level comprises one or more of performing context fusion at a hardware level, performing context fusion at a feature level, performing context fusion in middleware, and performing context fusion at an application layer.

9. An apparatus comprising:
at least one processor; and
at least one memory including computer program code, the at least one memory and the computer program code configured to, with the at least one processor, cause the apparatus at least to perform:
receive physical sensor data extracted from one or more physical sensors;
receive virtual sensor data extracted from one or more virtual sensors; and
perform context fusion of the physical sensor data and the virtual sensor data at an operating system level.

10. The apparatus of claim 9, wherein the at least one memory and computer program code are further configured to, with the at least one processor, cause the apparatus to perform a determination as to a context associated with a device in communication with sensors providing the physical sensor data and the virtual sensor data based on a result of the context fusion.

11. The apparatus of claim 9, wherein, to receive physical sensor data, the at least one memory and computer program code are configured to, with the at least one processor, cause the apparatus to receive physical sensor data at a processor in communication with the one or more physical sensors, the processor also being in communication with the one or more virtual sensors to receive the virtual sensor data and perform context fusion of the physical sensor data received with the virtual sensor data received.

12. The apparatus of claim 9, wherein, to receive physical sensor data, the at least one memory and computer program code are further configured to, with the at least one processor, cause the apparatus to receive physical sensor data from a sensor processor in communication with the one or more physical sensors, the sensor processor being in communication with the processor, the processor being configured to receive the virtual sensor data and perform context fusion of the physical sensor data received with the virtual sensor data received.

13. The apparatus of claim 12, wherein the sensor processor is configured to perform a first layer of context fusion, wherein the at least one memory and computer program code are further configured to, with the at least one processor, cause the apparatus to receive a result of the first layer of context fusion, and wherein performing context fusion comprises performing the context fusion of the physical sensor data received with the virtual sensor data.

14. The apparatus of claim 9, wherein, to perform context fusion, the at least one memory and computer program code are further configured to, with the at least one processor, cause the apparatus to perform first level context fusion of physical sensor data received with a first set of virtual sensor data at a first layer of the operating system, and performing second level context fusion of a result of the first level context fusion with a second set of virtual sensor data at a second layer of the operating system.

15. The apparatus of claim 9, wherein, to perform context fusion, the at least one memory and computer program code are further configured to, with the at least one processor, cause the apparatus to perform context fusion at a hardware level, performing context fusion at a feature level, and performing context fusion in middleware.

16. The apparatus of claim 9, wherein the at least one memory and computer program code are further configured to, with the at least one processor, cause the apparatus to perform context fusion including one or more of performing context fusion at a hardware level, performing context fusion at a feature level, performing context fusion in middleware, and performing context fusion at an application layer.

17. The apparatus of claim 9, wherein the apparatus is a mobile terminal and further comprises user interface circuitry configured to facilitate user control of at least some functions of the mobile terminal.

18. A computer program product comprising at least one computer-readable storage medium comprising computer-executable program code portions stored therein, the computer-executable program code portions comprising program code instructions for:
receiving physical sensor data extracted from one or more physical sensors;
receiving virtual sensor data extracted from one or more virtual sensors; and
performing context fusion of the physical sensor data and the virtual sensor data at an operating system level.

19. The computer program product of claim 18, further comprising program code instructions for enabling a determination to be made as to a context associated with a device in communication with sensors providing the physical sensor data and the virtual sensor data based on a result of the context fusion.

20. The computer program product of claim 18, wherein program code instructions for performing context fusion of the physical sensor data and the virtual sensor data at an operating system level include instructions for performing first level context fusion of physical sensor data received with a first set of virtual sensor data at a first layer of the operating system, and performing second level context fusion of a result of the first level context fusion with a second set of virtual sensor data at a second layer of the operating system.

21. (canceled)

22. (canceled)
